(19) United States
(12) Patent Application Publication
(10) Pub. No.: US 2002/0095475 A1
(43) Pub. Date: Jul. 18, 2002

(54) Frame handling for a thin client

(76) Inventors: Prasad Krothapalli, San Jose, CA (US); Ravi Pachipala, Fremont, CA (US); Mahesh Rangamani, Mountain View, CA (US); Amitabh Sinha, Redwood City, CA (US); Roopak Parikh, San Jose, CA (US); Ritesh Adval, San Jose, CA (US); Mark Tracy, Union City, CA (US)

Correspondence Address: PILLSBURY WINTHROP LLP, 1100 New York Avenue, N.W., East Tower, Ninth Floor, Washington, DC, 20005-3918, US

(21) Appl. No.: 09/765,077

(22) Filed: Jan. 17, 2001

(51) Int. Cl. G06F 15/16; G06F 9/00

(52) U.S. Cl. 709/217; 709/100

(57) ABSTRACT

A method for maintaining at a server frame context for a device that is unable to display multiple frames. The method includes generating a first data structure having a first pointer for a first frame and a second pointer for a second frame, and associating a first context indicator with the first data structure. The method then includes sending from a server to a device the first context indicator, the first pointer, and a first document pointed to by the first pointer.

### FIELD

This invention relates to obtaining a service using a communication device, and more specifically, to a mechanism for handling frames on behalf of a device that is not able to display multiple frames simultaneously.

### BACKGROUND

Increasingly, wireless communications devices such as cellular phones, personal digital assistants, handheld computers provide or are being required to provide services offered by internet based websites. Examples of services include, but are not limited to, stock trading, buying or selling goods, sports information, and the weather. The websites that provide services to wireless devices use a language, such as wireless markup language (WML) or handheld device markup language (HDML), that is typically different from the language used by websites that communicate with laptop or desktop computers. Unlike laptop or desktop computers, which have the processing power and high data rates that can typically support a browser that uses the resource demanding hypertext markup language (HTML), wireless devices often have weaker capabilities (lower processing power and small screens) and lower data rates that support browsers (micro-browsers) that uses less demanding languages such as WML, and HDML. Consequently, wireless devices often are unable to communicate with the HTML websites. WML, and HDML are referred to herein referred to as reduced content languages. Wireless devices that communicate using a reduced content language are referred to herein as reduced content devices.

One way to provide the services offered by a HTML website to wireless devices is to create a mirror website which communicates using reduced content language documents. The reduced content website or any website that communicates with a limited resource or ‘thin’ communications device is referred to herein as a ‘reduced content’ website. The HTML website is referred to herein as a ‘full-content’ website.

The reduced content language document(s) produced by the mirror website are typically based on HTML documents on the ‘full-content website. Some of the HTML documents include frame sets which divide up a screen into multiple distinct areas or frames, each of which can display a different HTML document. Since the reduced content devices have small screens, they are unable to display multiple frames simultaneously. Consequently, only one frame is displayed at a time. Changes to or input based on the frame being displayed can result in changes having to be made in other frames. Since the browser of the reduced content device cannot handle multiple frames—it only displays one screen at a time—it conventionally does not storelocally the other frames. Thus, it cannot make changes to the other frames when user input necessitates changes. However, changes to other frames is crucial in order for the user to experience the flow designed by the website designer.

Since frames are an important aspect of the design of many full content websites, it is desirable to provide the experience of frames on reduced content devices in the manner intended by a website designer. Consequently, changes to other frames besides the one being displayed on a reduced content device need to be accounted for. The present invention provides mechanisms for achieving this objective.

### SUMMARY

A method for maintaining, at a server, frame context for a device is described. The method includes generating a first data structure having a first pointer for a first frame and a second pointer for a second frame, and associating a first context indicator with the first data structure. The method then includes sending from a server to a device the first context indicator, the first pointer, and a first document pointed to by the first pointer.

### DESCRIPTION OF THE DRAWINGS

The present invention is illustrated by way of example, and not limitation, in the figures of the accompanying drawings in which like references denote similar elements, and in which:

FIG. 1 illustrates a block diagram of a system in which wireless and wired devices communicate with an application server;

FIG. 2a illustrates a screen divided into three frames;

FIG. 2b illustrates a data structure for a frameset having three frames;

FIG. 2c illustrates the elements of a list of data structures as a function of time;

FIG. 3 illustrates a process for handling frames on behalf of a device that is unable to display multiple frames simultaneously;

FIG. 4 illustrates a process for handling context indicators at a device that is unable to handle multiple frames;

FIG. 5 illustrates a process for handling context indicators and requests received from a device that is unable to display multiple frames;

FIG. 6 illustrates a block diagram of a server that handles frames on behalf of a device that is unable to display multiple frames simultaneously; and

FIG. 7 illustrates a block diagram of a telephone according to one embodiment of the present invention.

### DETAILED DESCRIPTION

Methods and apparatus for responding efficiently to an alert are described. In the following description, for purposes of explanation, numerous specific details are set forth in order to provide a thorough understanding of the present invention. It will be evident, however, to one skilled in the art that the present invention may be practiced in a variety of communication systems, especially wireless application protocol systems, and communications devices, especially telephones, without these specific details. In other instances, well-known operations, steps, functions and devices are not shown in order to avoid obscuring the invention.

Parts of the description will be presented using terminology commonly employed by those skilled in the art to convey the substance of their work to others skilled in the art, such protocol, gateway, render, store, interpret, and so forth. Also parts of the description will also be presented in terms of operations performed through the execution of programming instructions or initiating the functionality of some electrical component(s) or circuitry, using terms such as, performing, sending, processing, transmitting, configuring, and so on. As well understood by those skilled in the art, these operations take the form of electromagnetic, electrical, magnetic, or optical signals capable of being stored, transmitted, transferred, combined, and otherwise manipulated through electrical or electromechanical components.

Various operations will be described as multiple discrete steps performed in turn in a manner that is most helpful in understanding the present invention. However, the order of description should not be construed as to imply that these operations are necessarily performed in the order that they are presented, or even order dependent. Lastly, repeated usage of the phrases “in one embodiment,” “an alternative embodiment,” or an “alternate embodiment” does not necessarily refer to the same embodiment, although it may.

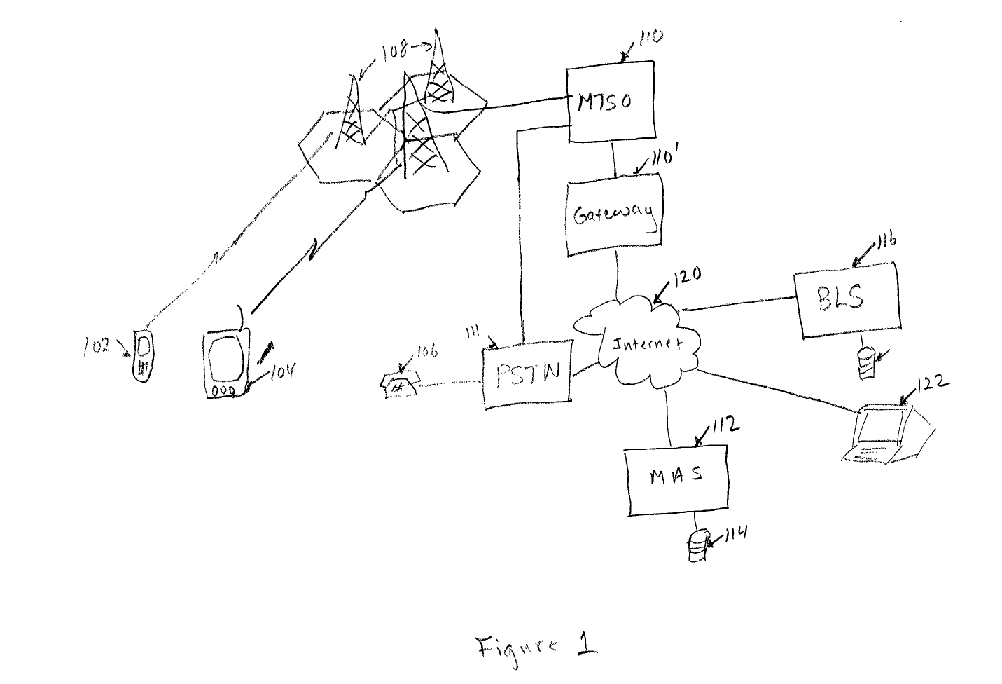

FIG. 1 illustrates a block diagram of a system in which wireless and wired devices communicate with an application server. System 100 includes telephone 102, personal digital assistant (PDA) 104, telephone 106, cellular stations 108, mobile telephone switching office (MTSO) 110, public switched telephone network switching office 111, mobile application server 112, storage 114, business logic server 116, gateway 110′, internet 120, and computer 122. Business logic server 116 is the host for a website with an address or uniform resource locator that is widely known. It is not unusual for a popular website to have millions of users, if not tens of millions. For purposes of illustration, the website has the following address: www.services.com. The website provides in various embodiments services including, but not limited to, retrieving stock quotes and airline flight information or sport scores, trading stock, buying and selling goods. Since the services are provided using hypertext markup language (HTML) documents or pages, the website is referred to as a ‘full content’ website. These services can be procured directly from server 116 using computer 122 because computer 122 has sufficiently high processing power, a large display, and high communications data rate to support a web browser that is capable of executing HTML code.

Telephone 102 and PDA 104, on the other hand, typically have relatively low processing power, small displays, and a low communications data rate. Consequently, they are unable to support a browser that executes HTML code or frames. In one embodiment, telephone 102 and PDA 104 have a browser that is capable of executing wireless markup language (WML) or handheld markup language (HDML) code, which require relatively less processing power and communications data rate, and are better suited for the small displays of telephone 102 and PDA 104. Telephone 102 and PDA 104 are referred to herein as ‘reduced content’ devices because their browsers use WML and HDML to render less graphically intensive displays. WML and HDML are referred to herein as reduced content languages.

The remaining description below is provided in the context of telephone 102 procuring service. It should be appreciated that the description is equally applicable to PDA 104, a handheld computer, or other communications devices that have user input and output interfaces and the ability to communicate with a wireless network.

The nature of the services provided by the full content website are such that they are desired by mobile users of telephone 102. Moreover, the operator of the full content website would like to service mobile users without having to change significantly the full content website. Since the full content website is typically not going to be modified so that it can specifically service reduced content devices and since the full content website communicates in HTML code, a user of telephone 102 cannot directly access the services of the full content website. Furthermore, the user of telephone 102 cannot directly access the services of the full content website because telephone 102 has a browser that is unable to display frames.

However, a user of telephone 102 can indirectly access the services of the full content website by using a reduced content website on server 112. Server 112 hosts a reduced content website that can take HTML documents from server 116 and reformat or represent them in a different manner so that they can be rendered on reduced content devices. For purposes of illustration, the reduced content website has the following address or URL: www.services.everypath.com. The reduced content website has a script for each page or document of the full content website. The script defines what is extracted from an HTML page and how it is to be presented on a reduced content device. Mechanisms for extracting data from an HTML document and representing it in a manner suitable for reduced content devices is the subject of co-pending patent application “Method for Converting Two-dimensional Data into a Canonical Representation” with Ser. No. 09/394,120, filed on Sep. 10, 1999, and co-pending patent application “Method for Customizing and Rendering of Selected Data Fields” with Ser. No. 09/393,133, filed on Sep. 10, 1999. Using the script, server 112 takes an HTML document and generates a page or pages in a language understood by a reduced content device. In one embodiment, server 112 generates WML or HDML documents that can be visually rendered at telephone 102. Alternatively, server 112 can generate audible voice information that can be heard using telephone 102.

For example, assume a user of telephone 102 desires to engage in a stock trade and that www.services.everypath provides a trading service. The user enters www.services.everypath into the telephone's browser which establishes contact with server 112 requests access to www.services.everypath.com—the details of establishing contact by way of stations 108, MTSO 110, and gateway 110′ will be described below. Server 112 recognizes from the request that telephone 102 is attempting to get to the home page of www.services.com which resides on server 116. Consequently, server 112 requests the home page from server 116. Using the script and the home page received from server 116, server 112 creates a reduced content page or pages that can be rendered by telephone 102. The reduced content pages are sent to telephone 102 by way of gateway 110′, MTSO 110, and cellular stations 108.

In one embodiment, the home page has fields for user identification and password that a user needs to fill in before submitting the page to server 112. The user can enter the information using the keypad (not shown) of telephone 102. After filling in the information requested by the home page, the user submits the page to server 112. Server 112 extracts the information filled in by the user and submits the information back to server 116. Server 116 replies back with a menu page, www.services.com/menu. Using a script associated with the menu and the menu page, server 112 generates a page in a language understood by the browser of telephone 102 and sends the generated page to telephone 102. The user then selects the trading link from the menu. Telephone 102 receives the trading page through substantially the same process just described in connection with retrieving the home page and the menu page. The user then enters the symbol of the stock, and quantity of shares to be bought or sold and posts the request. A WML or HDML confirmation page is then sent to telephone 102 from server 112 based on an HTML confirmation page retrieved from server 116.

In an alternative embodiment, the home, menu, trading, and confirmation pages are rendered through text-to-voice technology that presents audible choices to a user of telephone 102. A user responds to server 112 by pressing a key to generate a dual tone multi-frequency (DTMF) tone or speaking into the telephone's microphone.

In the manner described above, according to one embodiment, a user of a non-HTML communications device such as telephone 102 is able to procure the services of an HTML based website on server 116.

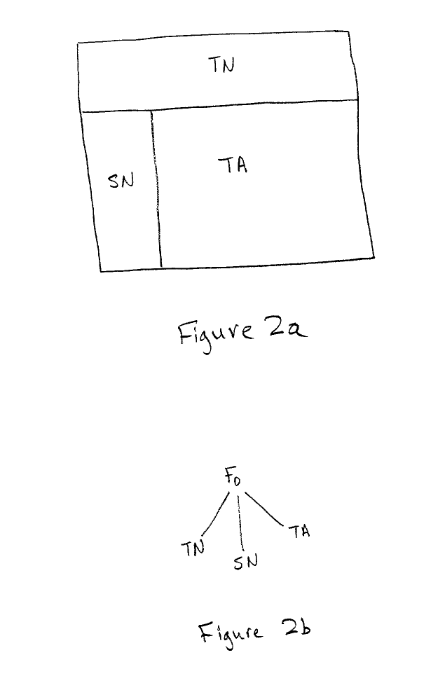

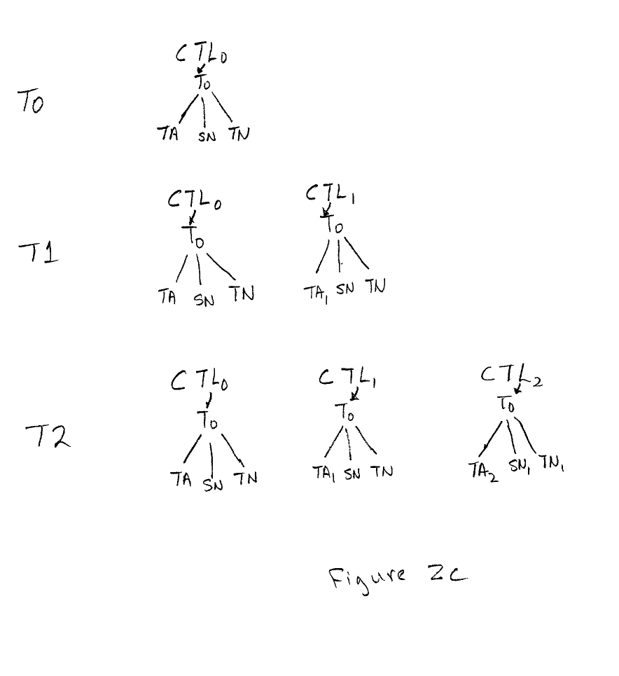

In the example given above, the HTML pages received by server 112 from server 116 did not contain frames. However, many full-content websites communicate using HTML pages that contain frames. Frames are divisions of a screen into two or more areas each of which can display different documents. FIG. 2a illustrates a screen divided into three frames. Screen 100 has a top navigation bar TN, a side navigation bar SN and a text area TA. The HTML page that is associated with screen 100 has a frameset that defines three separate frames each of can display a different document. While FIG. 2a illustrates a screen for a frameset that has only three frames, it should be appreciated that a screen can be divided into more than three frames and that a frame can itself be divided into two or more frames. Reduced content devices such as telephone 102 and PDA 104 have relatively small screens that do not provide a good environment for displaying multiple frames. Furthermore, reduced content devices typically have browsers that cannot handle a document that defines multiple frames. Consequently, server 112, as described herein, has to handle the multiple frames on behalf of telephone 102 and other reduced content devices. The present invention provides a mechanism for server 112 to handle frames of any number on behalf of a device that is unable to display multiple frames simultaneously.

Before describing the mechanism, the operation of system 100 will be described. In one embodiment, telephone 102 and PDA 104 communicate in accordance with wireless access protocol (WAP). WAP is an application environment and a group of protocols that define access of wireless devices to internet services. The application environment is uniform and does not depend on the underlying protocol for the communications air link. WAP is implemented or will be implemented on global system for mobile communications (GSM), interim standard (IS)-136, time-division multiple access (TDMA), personal communications service (PCS), and code division multiple access (CDMA), among other schemes. The present invention can be practiced with any application environment and communications protocols.

A WAP request from telephone 102 can be an hypertext protocol (HTTP) request including a URL such as http://www.services.everypath.com. Telephone 102 converts the text URL into a binary wireless session protocol (WSP) request. WSP is a protocol layer that defines efficient exchange of data between applications. Depending on the particular embodiment, the binary request is transmitted to cellular station 108 in accordance with one of the air link protocols indicated above. Station 108 forwards the binary request to MTSO 110. MTSO is the interface to the public switched telephone network for mobile phones making telephone calls to or receiving calls from telephones such as telephone 106. MTSO 110 directs internet traffic to and from gateway 110′ which is an interface between the wireless network and internet 120. Gateway 110′ converts the binary request to an HTTP request and sends the request to server 112 via internet 120.

As described above, server 112 recognizes that the request is for the login page at www.services.com. Thus, server 112 requests that server 116 send it the HTML document associated with the login page. Using a script associated with the login page, server 112 generates a text WML page (or pages) and sends it to gateway 110′. It should be appreciated that server 112 can generate a page in HDML, or some other language that is understood by a reduced content device, such as telephone 102. Gateway 110′ converts the text WML page into binary WML. Gateway 110′ sends the binary WML page using WSP protocol to MTSO 110 which forwards it to station 108. Station 108 transmits the binary WML page to telephone 102. Telephone 102 converts the binary WML page into a text WML page. The browser interprets or executes the text WML page to render a screen of information on the display of telephone 102.

In the event server 112 receives an HTML document that includes a frameset that defines multiple frames, server 112 handles the frameset on behalf of telephone 102. The process of handling the frameset is described in greater detail below. Since telephone 102 can only display one screen at a time, server 112 sends the document of only one frame at a time to telephone 102. Furthermore, since frames are often interrelated in the sense that changes or selection in one frame may affect the documents displayed in other frames (e.g., one document is replaced with another document) and since telephone 102 cannot handle the interrelation, server 112 has to make changes to frames that are not being displayed on telephone 102. For example, if a document associated with frame SN is currently displayed on telephone 102, a user selection or input may require server 112 to replace the document presently associated with frame TA with a new document. Based on predetermined rules or user request, server 112 may decide to display frame TA on the screen of telephone 102 and so it may send the new document associated with frame TA to telephone 102.

Over time, telephone 102 will have multiple documents stored in telephone 102's memory in the order that they were received. When a user of telephone 102 backtracks through the cache and makes a request, for proper handling of the request it is necessary to indicate to server 112 the document with which the request is associated and the documents that were associated with the frames that were not displayed on telephone 102. For telephone 102 to be able to provide this information to server 112, server 112 has to 1) keep track of both the document it sent for the frame it wants displayed at telephone 102 and the documents that are associated with the frames that were not displayed and 2) to provide the tracking information to telephone 102. When a user of telephone 102 makes a request, telephone 102 sends to server 112 the tracking information for both the document that is associated with the request and the documents that are associated with the frames that are not displayed. In this manner, server 112 is able to process the request properly in the context of the document currently being displayed on telephone 102's screen and the documents for the frames that are not being displayed.

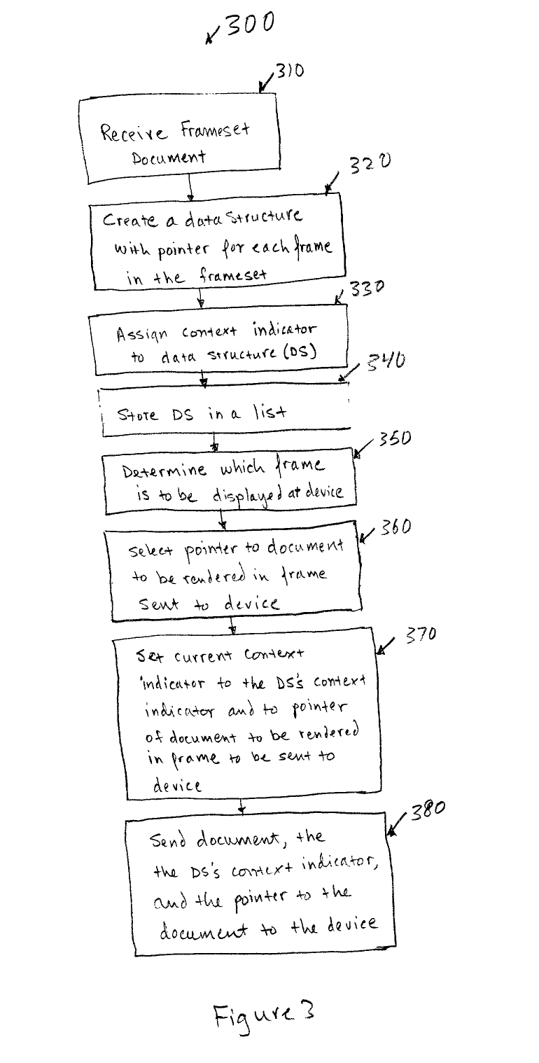

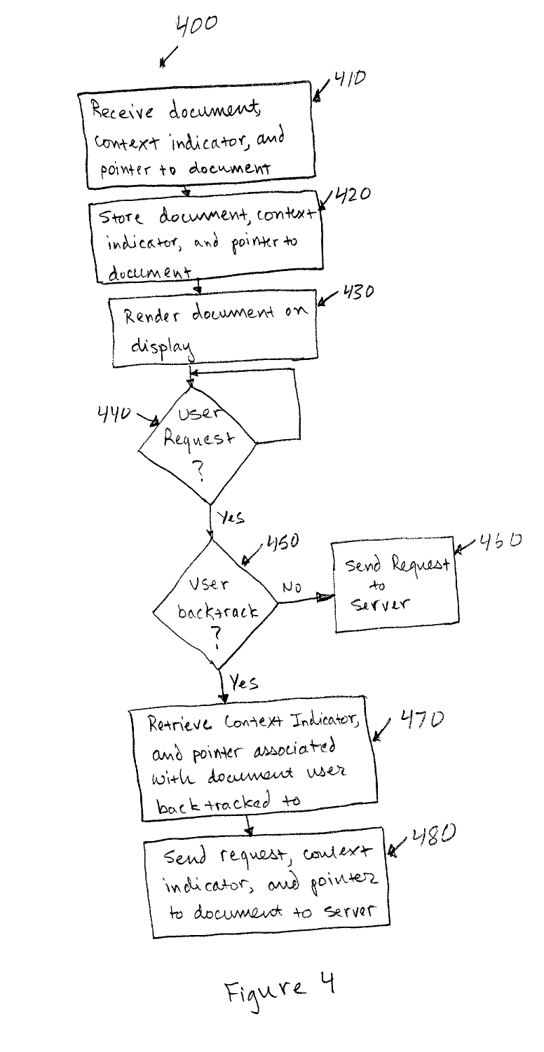

FIG. 3 illustrates a process for handling frames on behalf of a device that is unable to display multiple frames simultaneously. In process 300, server 112 receives 310 a document including a frameset that defines multiple frames. Each of the multiple frames has a document associated with it. Server 112 retrieves the document associated with each frame. Server 112 then creates 320 a data structure which describes the relationship among the frames. In one embodiment the data structure is a tree. FIG. 2b illustrates a tree 250 for a frameset having three frames. The root of the tree is the frameset, Fo. The tree has one pointer for each frame in the frameset. Each pointer is a URL that points to a document that the frameset indicates is associated with the frame. Tree 250 has three pointers: TN, SN and TA. Pointer TN is for frame TN. Pointer SN is for frame SN, and pointer TA is for frame TA. Server 112 then assigns 330 a context indicator to the data structure. The context indicator can be a number or any alphanumeric identifier that uniquely identifies the data structure. For example, the context indicator here could be 1. Server 112 then stores 340 the data structure in a list.

Server 112 then examines 350 rules it has for the HTML document being processed. Server 112 is provided with rules which indicate which frame is to be sent first to telephone 102 and what frame is to be sent in response to user input. Based on the rules, server 112 selects 360 a frame to send to telephone 102. For example, server 112 can select frame SN. Server 112 then sets 370 a current context indicator. The current context indicator is a combination of the context indicator of the data structure just created and the pointer to the frame being sent to telephone 102. For this example, the current context indicator would be 1 and SN. The current context indicator indicates the most recent frame sent to telephone and the specific data structure from which the most recent frame was selected. Server 112 then sends 380 to telephone 102 the document pointed to by pointer SN, the context indicator of the data structure and the pointer SN. Server 112 is in essence providing telephone 102 with tracking information (context indicator and pointer SN) that telephone 102 can send back to server 112 when a request is made so that server 112 knows that the request is being made in the context of the document pointed to by pointer SN and the context indicator for the data structure from which pointer SN was selected. Server 112 has to keep track of all the data structures from which it sent documents to telephone 102. Server 112 does this by storing the data structures or pointers to the data structures in a list.

Over time, as one document after another is sent from server 112 to telephone 102, server 112 will have stored in memory a list composed of several data structures. FIG. 2c illustrates the elements of a list of data structures as a function of time. At time t0, server 112 has only tree CTL0 in list 290. At time t1, server 112 has trees CTL0 and CTL1. Frame TA in tree CTL1 points to a document TA1 whereas in tree CTL0 frame TA points to document TA. This difference in the documents pointed to by the pointers for frame TA means that a user input has caused a new document (pointed to by TA1) to be loaded into the pointer for frame TA. At time t2, server 112 has trees, CTL0, CTL1, and CTL2 in list 290. There are differences in the documents pointed to by the pointers for frames TA, SN, and TN as one goes from CTL1 to CTL2. The differences indicate that user input necessitated: 1) the document pointed to by pointer TA2 to replace the document pointed to by pointer TA1 in frame TA; 2) the document pointed to by pointer SN1 to replace the document pointed to by pointer SN in frame SN; and 3) the document pointed to by pointer TN1 replaced the document pointed to by pointer TN in frame TN.

FIG. 4 illustrates a process for handling context indicators at a device that is unable to handle multiple frames. In process 400, telephone 102 receives 410 a document, a context indicator and a pointer to the document. Telephone 102 stores 420 the document in its cache, and stores the context indicator and the pointer to the document in memory. Telephone 102 then renders the document on its display. Telephone 102 then determines 440 if a user has made a request. If a user has made a request telephone 102 determines 450 whether the user has backtracked through the cache such that a document that had been sent earlier is now being displayed on the display of telephone 102. If the user has not backtracked through the cache, telephone 102 sends 460 the request to server 112. In an alternative embodiment, telephone 102 may send the request as well as the context indicator and the pointer to the document being displayed at telephone 102.

If the user has backtracked through the cache, telephone 102 retrieves 470 the context indicator and the pointer associated with the document to which the user has backtracked. Telephone 102 then sends 480 the request, the context indicator, and the pointer to the document to which the user backtracked to server 112.

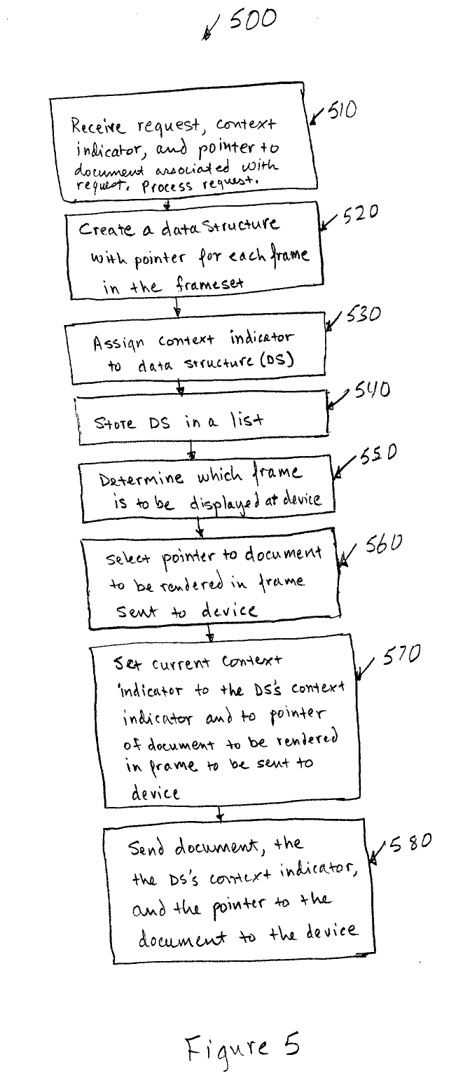

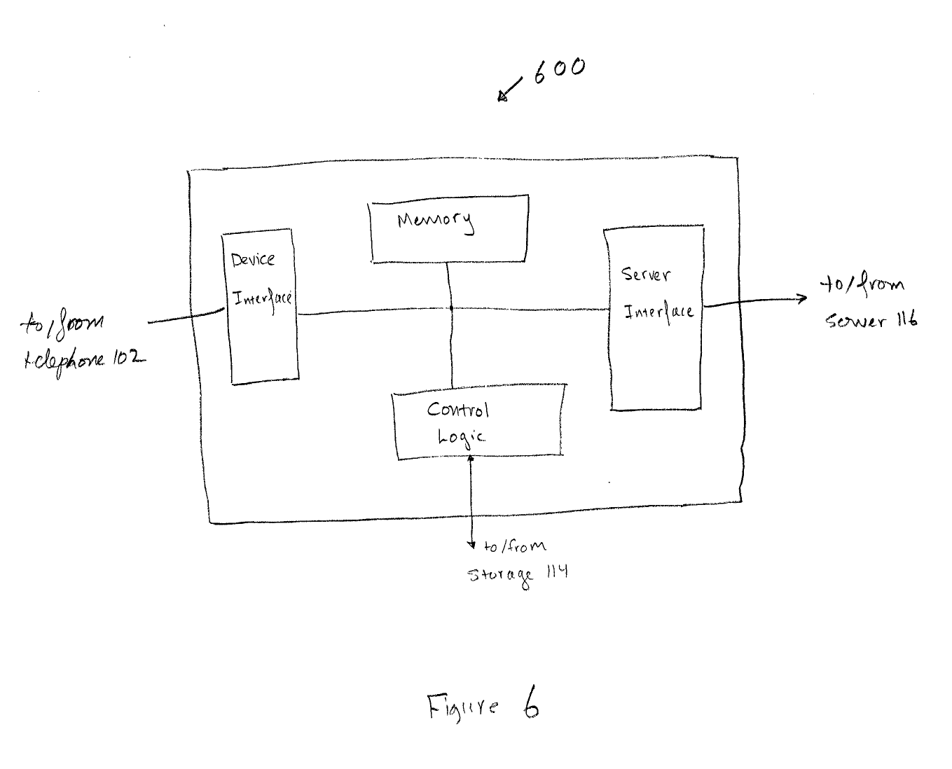

FIG. 5 illustrates a process for handling context indicators and requests received from a device that is unable to display multiple frames. In process 500, server 112 receives 510 from telephone 102 a request, a context indicator, and a pointer to a document associated with the request. Server 112 then processes the request in the appropriate context. In processing the request, server 112 associates a new document with at least one of the frames. For example, a user request associated with frame SN displayed at telephone 102 may require that a new document be associated with frame TA. Server 112 creates 520 a data structure which has the appropriate document associated with each frame. In other words, based on the request, new documents may have to be associated with each frame. Server 112 then assigns 530 a context indicator to the data structure. Server 112 then stores 540 the data structure in a list.

Server 112 then examines 550 rules it has to determine which frame is to be displayed at telephone 102. Based on the rules, server 112 selects 560 a frame to send to telephone 102. For example, server 112 can select frame TA. Server 112 then sets 570 a current context indicator. The current context indicator is a combination of the context indicator of the data structure just created and the pointer to the frame being sent to telephone 102. For this example, the current context indicator would be 2 and TA. The current context indicator indicates the most recent frame sent to telephone and the specific data structure from which the most recent frame was selected. Server 112 then sends 580 to telephone 102 the document pointed to by pointer TA, the context indicator of the data structure and the pointer TA.

FIG. 6 illustrates a block diagram of a server that handles frames on behalf of a device that is unable to display multiple frames simultaneously according to one embodiment of the present invention. Server 600 is representative of server 112 of FIG. 1. In one embodiment, server 600 includes device interface 610 that is to receive an HTTP request from gateway 110′. The HTTP request sent from gateway 110′ is based on a WAP request that gateway 110′ received from telephone 102. When server 112 receives an HTTP request, control logic 620 requests the appropriate HTML page from server 116. In the event the HTML page contains a frameset, control logic 620 retrieves the documents associated with each frame in the frame set. Control logic 620 then retrieves for each document a script from storage 114 and uses the script and the associated document to create a reduced content language document that can be understood by a reduced content device such as telephone 102. Logic 620 then creates a data structure that reflects the relationship among the frames and which contains pointers to the reduced content language document associated with each frame. Additionally, logic 620 assigns a unique context indicator to the data structure. Logic 620 stores the data structure in memory 630. Based on rules stored in memory 630, logic 620 selects a frame for display on telephone 102. Logic 620 sends to telephone 102 via interface 610 the reduced content language document associated with the frame selected, the context indicator for the data structure from which the frame was selected, and the pointer to the reduced content language document. Logic 620 also sets a current context indicator to the value of both the context indicator just created and the pointer to the frame selected for display at telephone 102. In the embodiment just described, server 600 operates in accordance with process 300 described above in connection with FIG. 3.

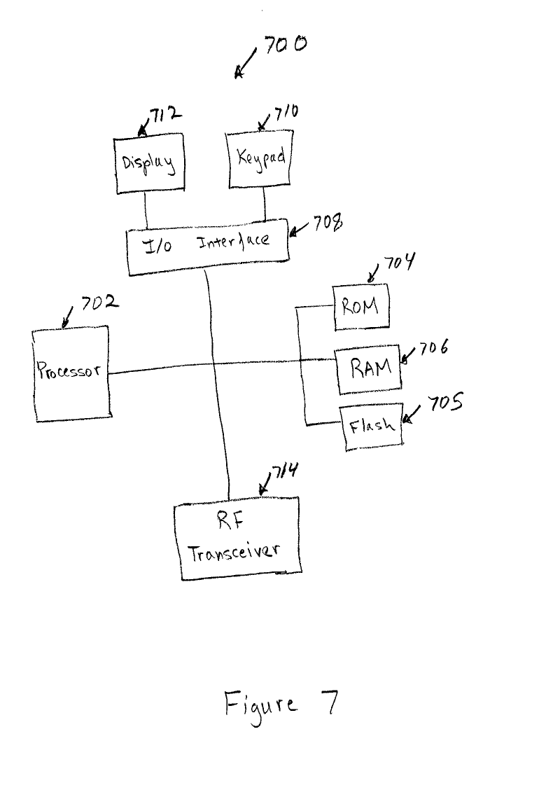

FIG. 7 illustrates a block diagram of a telephone. Telephone 102 includes processor 702, read only memory (ROM) 704, flash memory 705, random access memory (RAM) 706, user input/output interface 708, keypad 710, display 712, and radio frequency transceiver 714. A user of telephone 102, enters the URL (HTTP address) of a WAP website providing a desired service at keypad 710. Input/output (i/o) interface 708 receives the entry and renders it as text on display 712 and provides it to processor 702. Processor 702 executes software residing in RAM 706 and/or RAM 704. Under the command of the software instructions, processor 702 takes the URL and, if a communications link is available between telephone 102 and server 112, converts it to a binary WSP request and sends the WSP request to transceiver 314 which communicates with gateway 110′ by way of station 108. Gateway 110′ communicates with server 112 to retrieve a WML document associated with the URL entered at telephone 102. In the event the URL is for a document that contains a frameset, gateway 110′ retrieves a WML document that represents one of the frames in the frameset, a context indicator for the data structure at server 112 with which the WML document is associated, and a pointer that points to the WML document at server 112. Gateway 110′ sends to telephone 102 the WML document, a pointer to the WML document on server 112, and the context indicator for the data structure from which the WML document was selected.

Processor 702 stores the WML document, the context indicator, and the pointer to the document in memory 705. Processor 702 then instructs interface 708 to render the WML document just received on display 712. If a user makes a request with respect to the document currently being displayed, processor 702 sends to server 112 the request along with the context indicator and pointer to the document. Server 112 processes the request in the context of the context indicator and the pointer to the document. Server 112 generates a second data structure as described above and selects a document pointed to by one of the pointers in the data structure to send to telephone 102. With time, as the user makes a sequence of requests, telephone 102 will have in memory 705 a list of documents, context indicators and pointers to documents. When a user backtracks through the documents (i.e., screens of information) received, processor 702 keeps track of the document at which the user is looking. In the event the user makes a request while looking at a document to which the user backtracked, processor 702 sends to server 112 the request, the context indicator associated with the document at which the user was looking and the pointer to the document. In this embodiment just described, telephone 102 operates in accordance with process 400 of FIG. 4.

When server 112 receives the request, the context indicator, and the pointer to the document associated with the request, logic 620 processes the request in the appropriate context. In processing the request, logic 620 associates a new document with at least one of the frames. For example, a user request associated with frame SN displayed at telephone 102 may require that a new document be associated with frame TA. Logic 620 creates a data structure which has the appropriate document associated with each frame. In other words, based on the request, new documents may have to be associated with each frame. The new documents may be based on documents retrieved from server 116 through interface 640. Logic 620 then assigns a context indicator to the data structure. Logic 620 then stores the data structure in a list in memory 630.

Logic 620 then examines rules stored in memory 630 to determine which frame is to be displayed at telephone 102. Based on the rules, logic 620 selects a frame to send to telephone 102. For example, logic 620 can select frame TA. Logic 620 then sets a current context indicator in memory 630. The current context indicator is a combination of the context indicator of the data structure just created and the pointer to the frame being sent to telephone 102. For this example, the current context indicator would be 2 and TA. The current context indicator indicates the most recent frame sent to telephone and the specific data structure from which the most recent frame was selected. Logic 620 112 then sends to telephone 102 the document pointed to by pointer TA, the context indicator of the data structure and the pointer TA.

Thus, methods and apparatus for handling frames on behalf of a device that is unable to display multiple frames have been described. Although the present invention has been described with reference to specific exemplary embodiments, it will be evident to one of ordinary skill in the art that various modifications and changes may be made to these embodiments without departing from the broader spirit and scope of the invention as set forth in the claims. Accordingly, the specification and drawings are to be regarded in an illustrative rather than a restrictive sense.

We claim:

1. A method for maintaining at a server frame context for a device, the method comprising:
generating a first data structure having a first pointer for a first frame and a second pointer for a second frame;
associating a first context indicator with the first data structure; and
sending from a server to a device the first context indicator, the first pointer, and a first document pointed to by the first pointer.

2. The method of claim 1, further comprising:
receiving at a server from the device the first context indicator, the first pointer, and a request;
generating based on the request a second data structure with a third pointer for the first frame and a fourth pointer for the second frame.

3. The method of claim 1, further comprising:
receiving at a server from the device a request; and
generating based on the request a second data structure having a third pointer for the first frame and a fourth pointer for the second frame.

4. The method of claim 2, further comprising assigning the first context indicator and the first pointer to a current context indicator.

5. The method of claim 2, further comprising:
associating a second context indicator with the second data structure; and
sending to the device the second context indicator, the third pointer, and a second document pointed to by the third pointer.

6. The method of claim 2, further comprising:
associating a second context indicator with the second data structure; and
assigning the second context indicator and the third pointer to a current context indicator.

7. The method of claim 2, further comprising:
associating a second context indicator with the second data structure; and
sending to the device the second context indicator, the fourth pointer, and a second document pointed to by the fourth pointer.

8. The method of claim 2, further comprising:
associating a second context indicator with the second data structure; and
assigning the second context indicator and the fourth pointer to a current context indicator.

9. The method of claim 2, further comprising:
associating a second context indictor with the second data structure; and
placing the first context indicator and the second context indicator into a list in the relative order that the first context indicator and the second context indicator were generated.

10. The method of claim 2, further comprising:
assigning the first context indicator and the first pointer to a current context indicator;
wherein assigning the first context indicator precedes receiving at a server from the device the first context indicator;
assigning the second context indicator and the third pointer to the current context indicator;
wherein assigning the second context indicator occurs after receiving at a server from the device the first context indicator.

11. The method of claim 2, wherein the first pointer and the third pointer point to different documents.

12. The method of claim 2, wherein the second pointer and the fourth pointer point to different documents.

13. The method of claim 2, further comprising:
associating a second context indicator with the second data structure;
placing the first context indicator and the second context indicator into a list in the relative order that the first context indicator and the second context indicator were generated.

14. The method of claim 2, further comprising:
generating a third data structure with a fifth pointer to the first frame and a sixth pointer to the second frame;
associating a third context indicator with the third data structure;
sending the third context indicator, the fifth pointer, and a third document associated with the fifth pointer to the device;
receiving at the server from the device the first context indicator, the first pointer, and a request; and
generating based on the request a fourth data structure with a seventh pointer for the first frame and an eighth pointer for the second frame.

15. A method for maintaining at a server frame context for a device that is unable to display multiple frames, the method comprising:
generating a list including at least one data structure;
wherein each data structure includes at least two pointers and each of the at least two pointers corresponds to a different respective frame;
wherein each data structure has a corresponding respective context indicator; and
sending from a server to a device a first context indicator, a first pointer, and a first document pointed to by the first pointer.

16. The method of claim 15, further comprising:
receiving at the server from the device the first context indicator, the first pointer, and a request;
generating based on the request a new data structure;
associating a new context indicator with the new data structure;
placing the new data structure into the list; and
sending from the server to the device a new context indicator, a new pointer which is associated with the new data structure, and a new document pointed to by the new pointer.

17. The method of claim 16, further comprising:
assigning the first context indicator and the first pointer to a current context indicator; and
wherein the assigning the first context indicator occurs before receiving at the server from the device the first context indicator.

18. The method of claim 17, further comprising reassigning the first context indicator and the first pointer to the current context indicator after receiving at the server from the device the first context indicator.

19. The method of claim 16, wherein generating is also based on the first context indicator and the first pointer.

20. A method for maintaining frame context, the method comprising:
receiving at a device a context indicator that points to a data structure on a server;
wherein the data structure has at least two pointers each of which corresponds to a different respective frame; and
receiving at the device one of the at least two pointers and a document associated with the one of the at least two pointers.

21. The method of claim 20, the method further comprising sending from the device to the server the context indicator and the one of the at least two pointers.

22. The method of claim 21, wherein the sending occurs when a user backtracks to the document pointed to by the one of the at least two pointers and makes a request associated with the document.

23. The method of claim 21, the method further comprising sending from the device to the server a request associated with the contest indicator and the one of the at least two pointers.

24. The method of claim 20, the method further comprising storing the context indicator, the one of the at least two pointers and the document associated with the one of the at least two pointers.
